(19) United States
(12) Patent Application Publication
(10) Pub. No.: US 2015/0087176 A1
(43) Pub. Date: Mar. 26, 2015

(54) Interlocking Terminal

(71) Applicant: Lockheed Martin Corporation, Grand Prairie, TX (US)

(72) Inventors: Nicholas Arriola, Fort Worth, TX (US); Becky Wallace, Fort Worth, TX (US)

(73) Assignee: LOCKHEED MARTIN CORPORATION, Grand Prairie, TX (US)

(21) Appl. No.: 14/034,794

(22) Filed: Sep. 24, 2013

(51) Int. Cl. H01R 13/28

(52) U.S. Cl. CPC H01R 13/28
USPC 439/312; 439/877

(57) ABSTRACT

An embodiment electrical connector includes a body portion having a central aperture extending between a first surface and an opposing second surface, the first surface including indents and the second surface including corresponding detents and a wire post portion unitarily formed with the body portion, the wire post portion supporting a wire clamping feature and laterally offset relative to the central aperture of the body portion. An embodiment electrical connection system includes a first connector having a first central aperture, a first wire clamping feature laterally offset from the first central aperture, and first indents, and a second connector includes a second central aperture, a second wire clamping feature laterally offset from the second central aperture, and second detents. The second detents are configured to engage the first indents when the first and second connectors are mated to prevent rotation of the first connector relative to the second connector.

### BACKGROUND

A terminal lug, which may be referred to as simply a terminal, is an electrical connector used to electrically couple, for example, a wire to a bolt for the purpose of grounding or establishing an electrical connection.

A conventional terminal generally includes a wire-receiving end and a bolt-receiving end. The wire-receiving end is crimped in order to secure the wire in place. On the other hand, the bolt-receiving includes an aperture configured to receive the bolt. When a nut is threaded onto the bolt, the electrical connection is made.

When several wires need to be electrically connected to the same bolt, the various terminals used for this task may become cluttered together. To resolve this, the terminals may be fanned out around the single bolt. However, fanning out the terminals radially from the bolt may undesirably take up a significant amount of space.

### BRIEF DESCRIPTION OF THE DRAWINGS

For a more complete understanding of the present disclosure, and the advantages thereof, reference is now made to the following descriptions taken in conjunction with the accompanying drawing, in which:

FIGS. 1-3 illustrate an embodiment electrical connector from various viewpoints;

FIGS. 4-5 illustrate a pair of the electrical connectors of FIG. 1 having a wire post portion on opposing sides of a central aperture;

FIGS. 6-7 illustrate the pair of electrical connectors of FIGS. 4-5 stacked or mated together;

FIG. 8 illustrates one group of electrical connectors stacked upon and rotated relative to a second group of electrical connectors such that wires may be received from different directions;

FIGS. 9-10 illustrate a pair of electrical connectors each having two wire post portions;

FIGS. 11-12 illustrate the pair of electrical connectors of FIGS. 9-10 stacked or mated together; and

FIGS. 13-16 illustrate a stud adapter and a cap adapter that may be used in conjunction with the electrical connectors.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the present embodiments are discussed in detail below. It should be appreciated, however, that the present disclosure provides many applicable inventive concepts that can be embodied in a wide variety of specific contexts. The specific embodiments discussed are merely illustrative, and do not limit the scope of the disclosure.

The present disclosure will be described with respect to embodiments in a specific context, namely an electrical connector (a.k.a., terminal lug, terminal, etc.) for use in grounding or other electrical connections. The disclosure may also be applied, however, to other electrical connectors, electrical components, and the like.

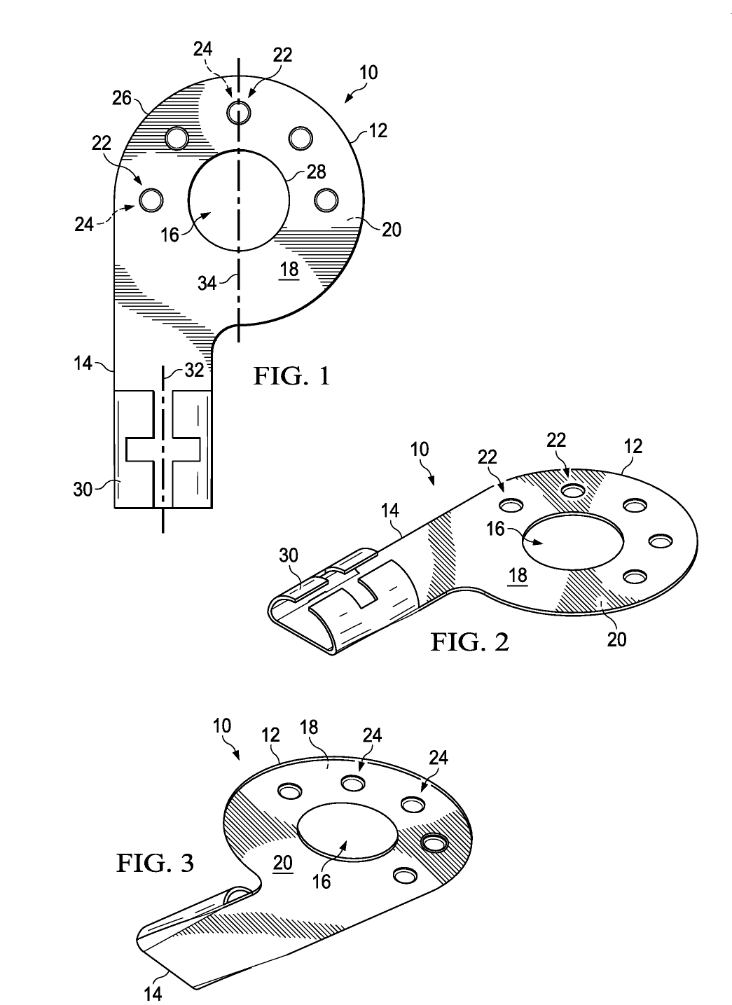

Referring now to FIGS. 1-3, an embodiment electrical connector 10 is illustrated. As will be more fully explained below, the electrical connector 10 includes variable interlocking features and inhibits or prevents rotation when torque is applied. The electrical connector 10 may be stacked with other similar mating electrical connectors in a manner that preserves space and prevents wires from having to be fanned out around a stud. In other words, the electrical connector 10 allows for more terminations per stud while reducing the space footprint, which improves cable routing and grouping. In addition, the electrical connector 10 provides a secure connection to mating electrical connectors and improves the electrical bond between mating terminals due to surface to surface geometry.

As shown, the electrical connector 10 includes a body portion 12 and a wire post portion 14. The body portion 12 has a central aperture 16 generally extending between a top surface 18 and a bottom surface 20. The central aperture 16 is generally sized and dimensioned to receive, for example, a stud (e.g., a ground stud connection, etc.). The top surface 18 of the body portion includes indents 22 while the bottom surface includes corresponding detents 24. While five indents 22 and corresponding detents 24 are depicted in FIGS. 1-3, it should be recognized that more or fewer of the indents 22 and detents 24 may be included on the electrical connector 10 in other embodiments. In addition, while mating indents and detents are depicted in FIG. 1, it should be recognized that other interlocking features with various different shapes, dimensions, orientations, or methods of operation may be employed.

In an embodiment, a body portion periphery 26 is generally concentric with a central aperture periphery 28. In addition, in an embodiment the indents 22 and detents 24 are interposed between the body portion periphery 26 and a central aperture periphery 28. Indeed, as shown the indents 22 and detents 24 are generally concentric with the body portion periphery 26 and the central aperture periphery 28.

While the indents 22 and detents 24 are shown spaced approximately equally between the body portion periphery 26 and the central aperture periphery 28 in FIGS. 1-3, the indents 22 and detents 24 may be otherwise arranged on the body portion 12. For example, the indents 22 and detents 24 may be moved closer to the body portion periphery 26 or closer to the central aperture periphery 28.

Moreover, while the indents 22 and detents 24 and generally disposed on the body portion 12 in an area opposite the wire post portion 14 in FIG. 1, the indents 22 and detents 24 may be disposed closer to the wire post portion 14 of the electrical connector 10. Also, the indents 22 and detents 24 may be oriented on a left side of the body portion 12 alone, may be oriented on the right side of the body portion 12 alone, may entirely encircle or surround the central aperture 16, may be spaced apart from each other a non-uniform distance, and so on.

Still referring to FIGS. 1-3, the wire post portion 14 of the electrical connector 10 is generally unitarily formed with the body portion 12. In other words, the entire electrical connector 10 may be formed from a single piece of electrically-conductive material. In addition, the wire post portion 14 generally supports or includes a wire clamping feature 30. By way of example, the wire clamping feature 30 may be opposing tabs that can be crimped down onto a wire (not shown) received by the wire post portion 14. It should be recognized that the wire clamping feature 30 may be formed from a variety of different structures suitable for receiving and either temporarily or permanently holding a wire in place to achieve an electrical connection.

As shown in FIGS. 1-2, in an embodiment the wire clamping feature 30 projects away from the wire post portion 14 in a direction of the top surface 18 of the body portion 12. In an embodiment, the wire clamping feature 30 may also project away from the wire post portion 14 in a direction of the bottom surface 20 of the body portion 12.

Also, as shown in FIG. 1, the wire post portion 14 is laterally offset relative to the central aperture 16 of the body portion 12. While the wire post portion 14 is offset to the left of the central aperture 16 as oriented in FIG. 1, it should be recognized that the wire post portion 14 may also be offset to the right of the central aperture 16 in other embodiments.

Because the wire post portion 14 is offset from the central aperture 16, a center line 32 (shown in dashed lines) of the wire post portion 14, which coincides with the location and direction of the wire that would be received and held by the wire clamping feature 30, and a center line 34 of the central aperture 16 (shown in dashed lines) are parallel to each other, but horizontally misaligned.

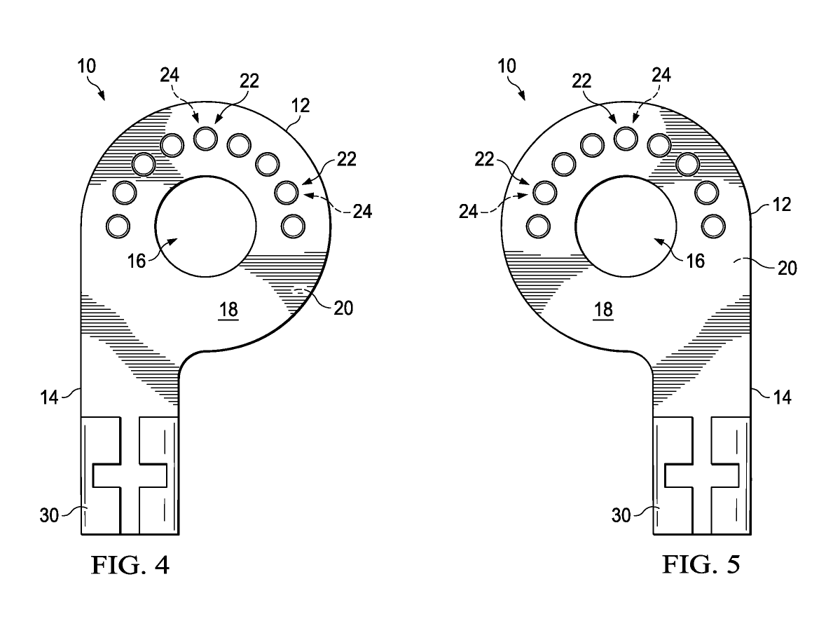

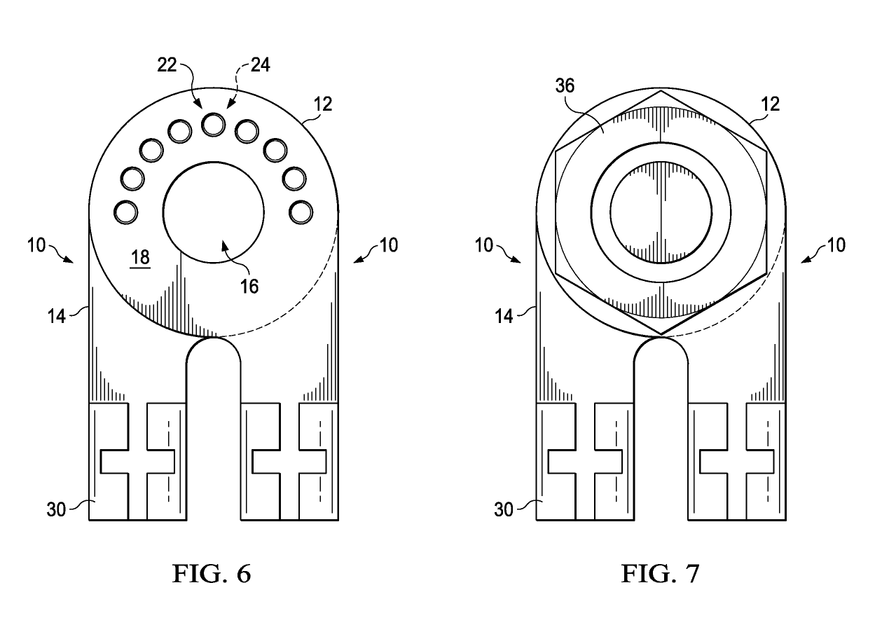

Referring now to FIGS. 4-5, a pair of the electrical connectors 10 is illustrated. As shown, the electrical connectors 10 in FIGS. 4-5 each include indents 22 on the top surface 18 and detents projecting from the bottom surface 20. However, the wire post portion 14 of the electrical connector 10 in FIG. 4 is offset to the left of the central aperture 16 while the wire post portion 14 of the electrical connector 10 in FIG. 5 is offset to the right of the central aperture 16. As such, the electrical connectors may be conveniently stacked or mated together as shown in FIG. 6.

When stacked as shown in FIG. 6, the detents 24 projecting from the bottom surface 20 of one electrical connector 10 are received with the indents 22 in the top surface 18 of the other electrical connector 10. When the indents 22 and detents 24 are engaged in this manner, rotation of one electrical connector 10 relative to another electrical connector 10 is inhibited or prevented. In addition to the indents 22 and detents 24 of the two electrical connectors 10 discouraging rotation, the wire post portions 14 also inhibit or prevent rotation of one electrical connector 10 relative to another electrical connector 10.

Indeed, as shown in FIG. 6, the electrical connector 10 having the wire post portion 14 offset on the right is prevented from rotating clockwise by the electrical connector 10 having the wire post portion 14 on the left. Likewise, the electrical connector 10 having the wire post portion 14 offset on the left is prevented from rotating counterclockwise by the electrical connector 10 having the wire post portion 14 on the right.

Referring now to FIG. 7, after a suitable amount of the electrical connectors 10 are stacked one on top of another as shown in FIG. 6, a nut 36 may be threaded onto a stud (e.g., a ground connection) to hold the electrical connectors 10 down. While a nut 36 is shown in FIG. 7, it should be recognized that numerous other locking features, either temporary or permanent, may be employed to maintain the electrical connectors 10 coupled to each other and fastened securely to the stud.

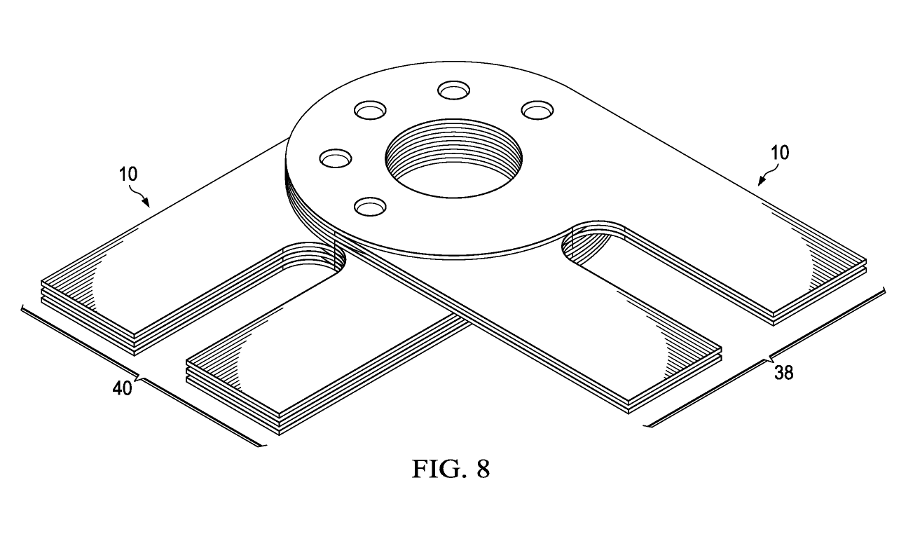

Referring now to FIG. 8, in an embodiment one group 38 of stacked electrical connectors 10 may be rotated relative to another group 40 of stacked electrical connectors 10 such that wires (not shown) may be received from different directions. In order to accomplish the rotation of groups 38, 40 of connectors, the pattern of indents 22 and detents 24 on a lowest one of the electrical connectors 10 in upper group 38 and the pattern of indents 22 on an uppermost one of the electrical connectors 10 in the lower group 40 may have to be adjusted or manipulated. Or, in the alternative, an adapter plate with a different indent 22 and detent 24 pattern or configuration may be utilized to mate the upper group 38 with the lower group 40 as shown in FIG. 8.

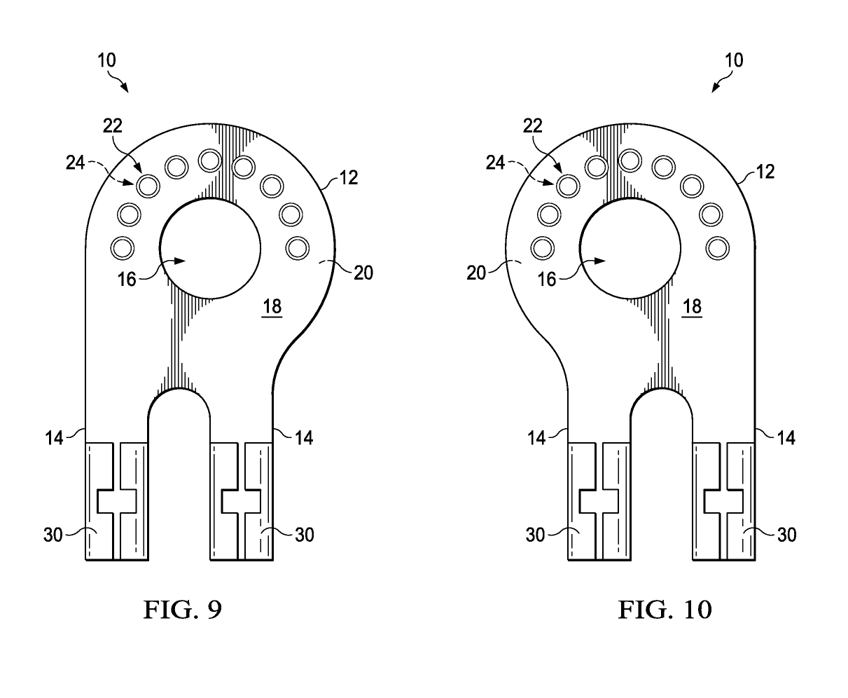

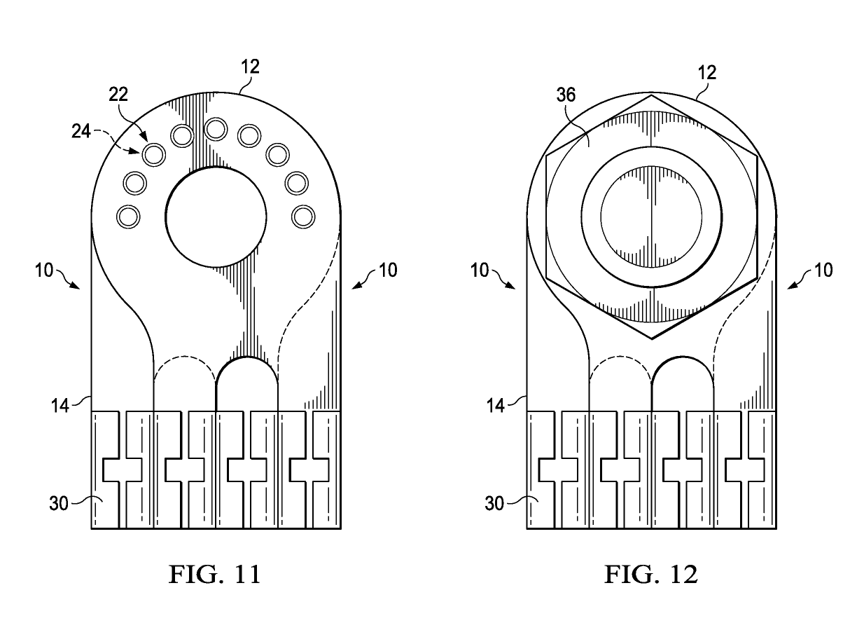

Referring now to FIGS. 9-10, a pair of the electrical connectors 10 is illustrated. As shown, the electrical connectors 10 in FIGS. 9-10 each include indents 22 on the top surface 18 and detents projecting from the bottom surface 20. However, each of the electrical connectors 10 includes two of the wire post portions 14. For example, the electrical connector 10 of FIG. 9 includes a wire post portion 14 offset to the left of the central aperture 16 and another wire post portion 14 offset to the right of the central aperture 16. Likewise, the electrical connector 10 of FIG. 10 also includes a wire post portion 14 offset to the left of the central aperture 16 and another wire post portion 14 offset to the right of the central aperture 16. As such, the electrical connectors may be conveniently stacked or mated together when mounted onto the stud as depicted in FIGS. 11-12. As shown, when the electrical connectors 10 are stacked as shown in FIGS. 11-12, the wire post portions 14 lock into place with one another to prevent rotation of the mated or stacked electrical connectors 10.

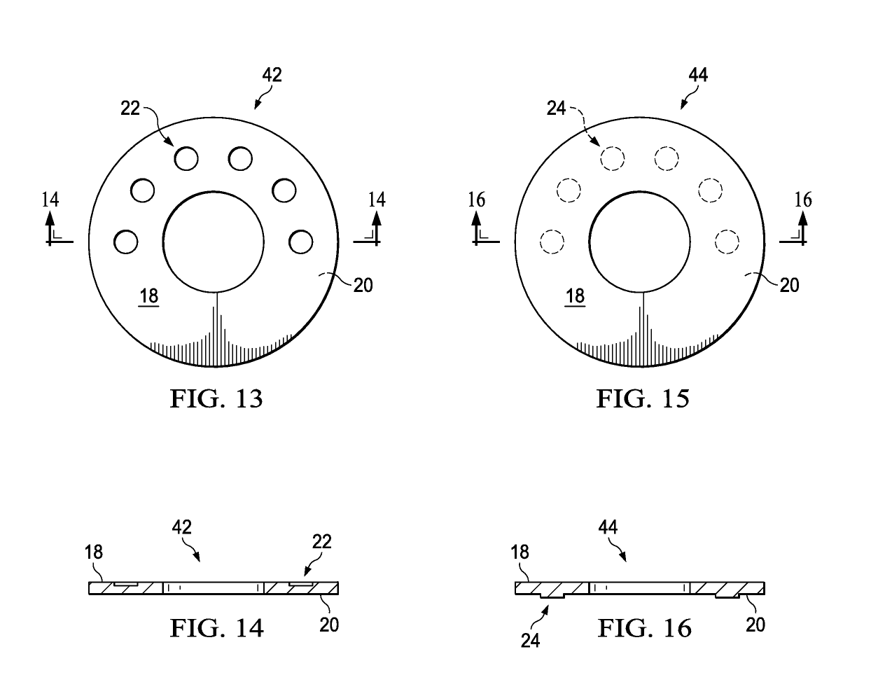

Referring now to FIGS. 13-16, the electrical connectors 10 disclosed herein may be used in conjunction with a stud adapter 42 and a cap adapter 44. As shown in FIGS. 13-14, the stud adapter 42 has indents 22 in the top surface 18 and a flat or planar bottom surface 20. As such, the stud adapter 42 is configured to receive the detents 24 of the lowermost electrical connector 10 in a stack and to engage a large surface area surrounding the stud received in the central aperture 16. Likewise, as shown in FIGS. 15-16, the cap adapter 44 has detents 24 on the bottom surface 20 and a flat or planar top surface 18. As such, the cap adapter 44 is configured to fill the indents 22 of the uppermost electrical connector 10 in a stack and to engage a large surface area of the nut 36 holding the stack in place around the stud. Therefore, it should be recognized that the stud adapter 42 and the cap adapter 44 improve the electrical bond for mating terminals.

From the foregoing, it should be recognized that the embodiment electrical connectors 10 offer numerous benefits and advantages. In particular, when stacked the embodiment electrical connectors 10 inhibit or prevent rotation using mated indents and detents on opposing devices and/or abutting wire post portions (e.g., legs). In addition, the embodiment electrical connectors 10 allow for efficient cable routing and grouping as well as saving space and reducing the overall footprint of the connection.

While the disclosure provides illustrative embodiments, this description is not intended to be construed in a limiting sense. Various modifications and combinations of the illustrative embodiments, as well as other embodiments, will be apparent to persons skilled in the art upon reference to the description. It is therefore intended that the appended claims encompass any such modifications or embodiments.

What is claimed is:

1. An electrical connector, comprising:
a body portion having a central aperture extending between a first surface and an opposing second surface, the first surface including indents and the second surface including corresponding detents; and
a wire post portion unitarily formed with the body portion, the wire post portion supporting a wire clamping feature and laterally offset relative to the central aperture of the body portion.

2. The electrical connector of claim 1, wherein the wire clamping feature projects away from the wire post portion in a direction of the first surface of the body portion.

3. The electrical connector of claim 1, wherein the wire clamping feature projects away from the wire post portion in a direction of the second surface of the body portion.

4. The electrical connector of claim 1, wherein a body portion periphery is generally concentric with a central aperture periphery.

5. The electrical connector of claim 1, wherein the indents and detents are interposed between a body portion periphery and a central aperture periphery.

6. The electrical connector of claim 1, wherein the indents and detents are concentric with a body portion periphery and a central aperture periphery.

7. The electrical connector of claim 1, wherein the indents and detents are disposed on the body portion in an area opposite the wire post portion.

8. The electrical connector of claim 1, wherein the body portion and the wire post portion are each formed from an electrically-conductive material.

9. The electrical connector of claim 1, wherein the indents of the body portion are configured to mate with mating detents on a first adapter and the detents of the body portion are configured to mate with mating indents on a second adapter.

10. The electrical connector of claim 1, wherein a second wire post portion is unitarily formed with the body portion, the second wire post portion on an opposing side of the central aperture relative to the wire post portion and supporting a second wire clamping feature.

11. An electrical connection system, comprising:
a first connector having a first central aperture, a first wire clamping feature laterally offset from the first central aperture, and first indents; and
a second connector having a second central aperture, a second wire clamping feature laterally offset from the second central aperture, and second detents, the second detents configured to engage the first indents when the first and second connectors are mated to prevent rotation of the first connector relative to the second connector.

12. The electrical connection system of claim 11, wherein the first connector includes a first wire post portion and the second connector includes a second wire post portion, the first and second wire post portions configured to engage each other to prevent rotation of the first connector relative to the second connector.

13. The electrical connection system of claim 11, wherein the first wire clamping feature is laterally offset from the first central aperture on one side and the second wire clamping feature is laterally offset from the second central aperture on another side.

14. The electrical connection system of claim 11, wherein the first wire claiming feature and the second wire clamping feature project in a same direction when the first and second connectors are mated.

15. The electrical connection system of claim 11, wherein the first connector includes first detents corresponding to the first indents and the second connector includes second indents corresponding to the second detents.

16. The electrical connection system of claim 11, wherein the first connector and the second connector are entirely formed from an electrically-conductive material.

17. The electrical connection system of claim 11, wherein the first connector includes a third wire clamping feature and the second connector includes a fourth wire clamping feature, the first and third wire clamping features on opposing sides of the first central aperture and the second and fourth wire clamping features on opposing sides of the second central aperture.

18. An electrical connection system, comprising:
a first connector having a first central aperture, a first wire clamping feature laterally offset from the first central aperture in a first direction, first detents projecting away from the first wire clamping feature, and first indents corresponding to the first detents; and
a second connector having a second central aperture, a second wire clamping feature laterally offset from the second central aperture in a second direction opposite the first direction, second detents projecting away from the second wire clamping feature, and second indents corresponding the second detents, the second indents configured to engage the first detents when the first and second connectors are stacked.

19. The electrical connection system of claim 18, further comprising a stud adapter having a planar bottom surface and stud indents on a top surface, the stud indents configured to engage the first detents on the first connector.

20. The electrical connection system of claim 18, further comprising a cap adapter having a planar upper surface and cap detents on a bottom surface, the cap detents configured to engage the second detents on the second connector.
